(19) United States
(12) Patent Application Publication
(10) Pub. No.: US 2007/0058691 A1
(43) Pub. Date: Mar. 15, 2007

(54) Electronic thermometer

(75) Inventor: Herman Lee, Hsinchu (TW)

Correspondence Address: TROXELL LAW OFFICE PLLC, SUITE 1404, 5205 LEESBURG PIKE, FALLS CHURCH, VA, 22041, US

(73) Assignee: Oriental System Technology INC.

(21) Appl. No.: 11/224,991

(22) Filed: Sep. 14, 2005

(51) Int. Cl. G01K 1/00; G01K 7/00

(52) U.S. Cl. 374/208; 374/163

(57) ABSTRACT

An electronic thermometer comprises a first case, a second case, a metal tip section, a temperature sensor device and a cap. The first case made of rigid material, being hollow body, has a recession disposed on an outer periphery thereof. The second case has a cover section and a connecting section, both made of flexible material and a probe section made of rigid material, the cover section covers overall the firsts case and catch on the recession, a mating stem integrally forms with shrinkage at a distal end of the cover section, the connecting section forms a first roughness thereof. The probe section has two end parts wherein one end part forms a second roughness for corresponding to the first roughness; accordingly, the mating stem can be insert into the probe section and the probe section can firmly engage with the connecting section by the first roughness and the second roughness when assembly.

### BACKGROUND OF THE INVENTION

1. Field of the Invention

The present invention relates to an electronic thermometer, and particularly to an electronic thermometer characterizing a firmly assembly of structure, a usage of convenience and comfort, and an accurate detection of temperature.

2. Prior Art

In general, an electronic thermometer has been a common medical necessity for a family; by way of contacting a human's armpit, anus or under tongue for detecting temperature. A case and a probe stem of a conventional electronic thermometer are generally made of hard plastic material and formed integrally, resulting from such a hard case and hard probe stem, users may feel uncomfortable and inconvenient. Therefore, many improvements have been made for providing a flexible probe stem attached to a hard case, for example, as disclosed in U.S. Pat. Nos. 5,013,161, 5,165,798 or 6,637,935.

However, all these improved thermometers still suffer drawbacks as described below:
1. Inefficient flexibility—a flexible probe stem is entirely adhered to a hard case; therefore, the flexible probe stem forms part of the hard stem and is unable to be bent.
2. Unsteady connection condition—thanks to a metal tip of the flexible probe stem is mounted to a hard case over a supporting stem, a connection side between the two different members plays a primary part of keeping firmly engaging condition. However, for conventional electronic thermometers, the connection side did not provide a sufficient interferential engagement. That is, the flexible probe stem and a hard case become easily to break off. Furthermore, conventional electronic thermometers proceed with detected temperature by an electronic processor, and the detected temperature is sensed by the metal tip; therefore, if the metal tip fails to reliably keep the detected temperature therein, the detected temperature might be influenced by other factors, even a slight change of temperature around the metal tip will be immediately reflected on the electronic processor, and which will cause the detected temperature being inaccurate.

### SUMMARY OF THE INVENTION

Accordingly, an object of the present invention is to provide an electronic thermometer which has a firmly assembly, a convenient and comfortable usage, and an accurate temperature detection.

To achieve the above object, an electronic thermometer in accordance with the present invention includes a first case, a second case, a metal tip section, a temperature sensor device and a cap. The first case made of rigid material, being hollow body, which has two distal openings opposite to each other and a viewing opening located at a midsection thereof and at least a recession disposed on an outer periphery thereof. The second case has a cover section and a connecting section, both made of flexible material and a probe section made of rigid material, the cover section covers overall the firsts case and catch on the recession, a mating stem integrally forms with shrinkage at a distal end of the cover section, the connecting section forms a first roughness at a distal end thereof. The probe section has two end parts wherein one end part forms a second roughness for corresponding to the first roughness of the connecting section; accordingly, the mating stem can be insert into the probe section and the probe section can firmly engage with the connecting section by the first roughness and second roughness when assembly.

Another object of the present invention is that a thermal insulator disposed on an inner of the metal tip section, a thermal sensor located at a top of an inner side of the metal tip section against the thermal insulator, wires has two end and being positioned through the thermal insulator wherein one end thereof connecting the thermal sensor for accurately detecting temperature, and the other end connecting a temperature sensor device.

Other objects, advantages and novel features of the present invention will be drawn from the following detailed embodiment of the present invention with the drawings.

### BRIEF DESCRIPTION OF THE DRAWINGS

FIG. 1 is an exploded perspective view of an electronic thermometer in accordance with a preferred embodiment of the present invention;

FIG. 2 is a top view of the electronic thermometer of the present invention;

FIG. 3 is a side view of the electronic thermometer of the present invention;

FIG. 4 is a cross-sectional view of FIG. 2 taken along line 4-4;

FIG. 5 is a cross-sectional view of FIG. 3 taken along line 5-5; and

FIG. 6 is a cross-sectional view of FIG. 2 taken along line 6-6.

### DESCRIPTION OF THE PREFERRED EMBODIMENT

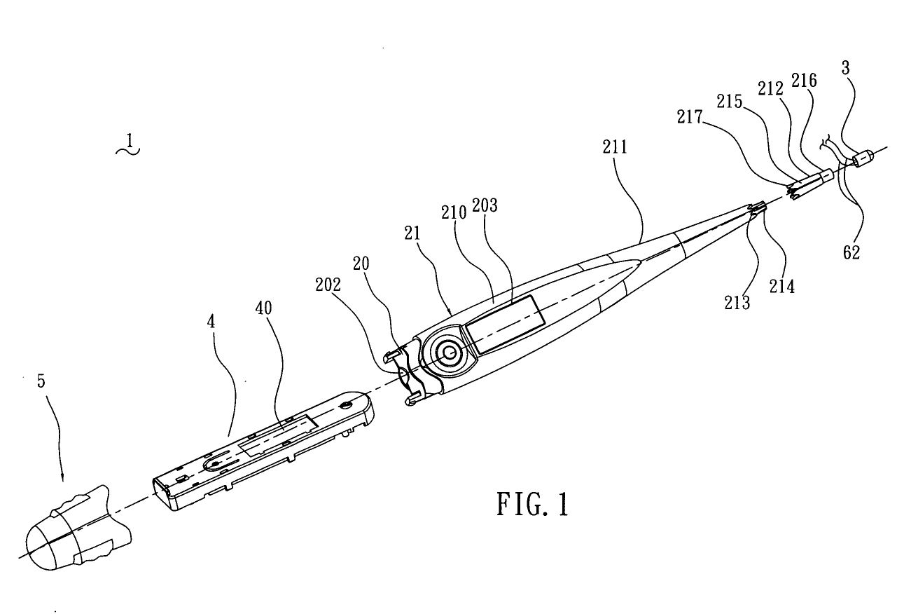

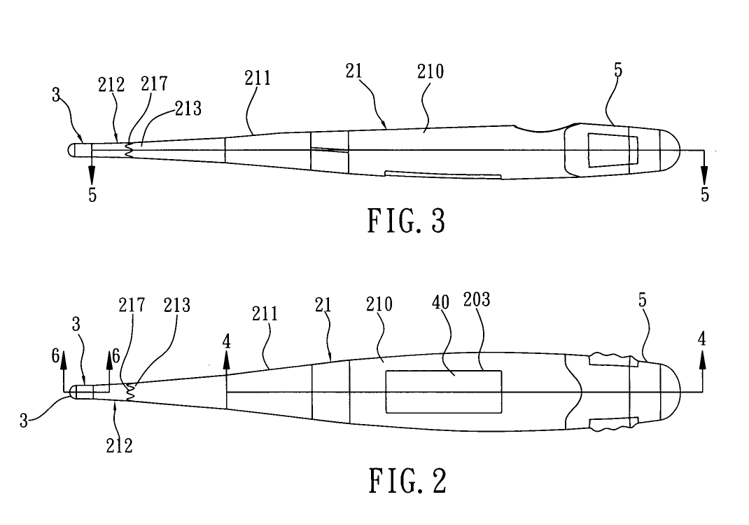

With reference to FIGS. 1 to 5, an electronic thermometer 1 in accordance with a preferred embodiment of the present invention comprises: a first case 20, a second case 21, a metal tip section 3, a temperature sensor device 4 and a cap 5, wherein the first case 20 is a hollow body and made of rigid material such as PC, PP, ABS and which has two distal openings 201, 202 opposite to each other, a viewing opening 203 located at a midsection of the first case 20 and a recession 204 disposed on an outer periphery thereof for facilitating a better attachment. The second case 21 comprises a cover section 210 and a connecting section 21, both made of flexible material such as TPR, and a probe section 212 made of rigid material such as PC, PP, ABS. The cover section 210 covers the firsts case 20 and catch on the recession 204, a mating stem 214 integrally forms with shrinkage at a distal end of the cover section 210. The connecting section 211 forms a first roughness 213 at a distal end thereof, which is shape of serration. The probe section 212 has two end parts 215, 216 wherein one end part 215 forms a second roughness 217 for corresponding to the first roughness 213 of the connecting section 211 which is also shape of serration, the opposite end part 216 forms a smaller size than the end part 215 for providing the metal tip section 3 mounted on thereof. Accordingly, the mating stem 214 can be inserted into the probe section 212 and the probe section 212 can firmly engage with the connecting section 211 because of a sufficient interferential engagement provided by the first roughness 213 and second roughness 217 when assembly.

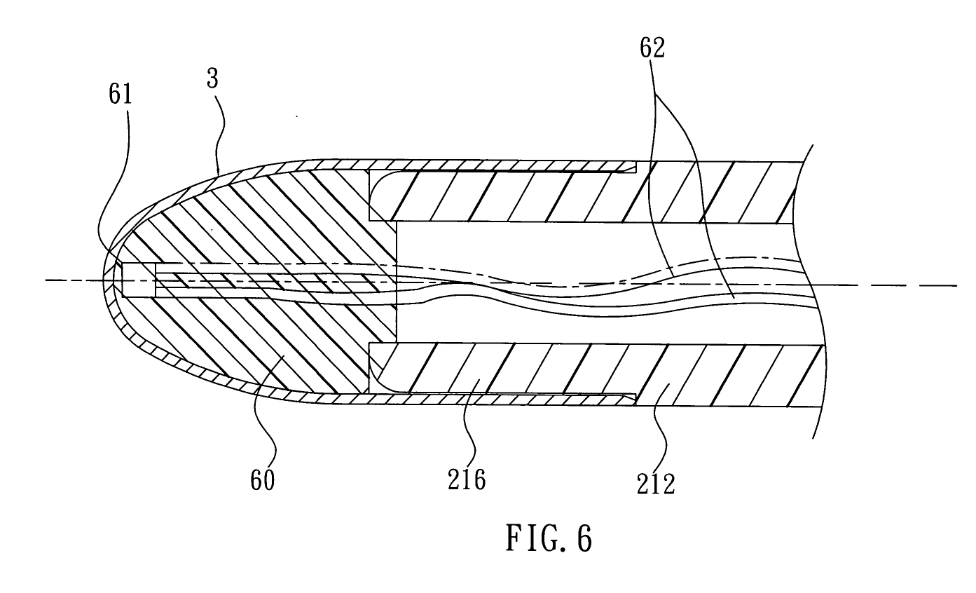

With reference to FIG. 6, the metal tip section 3 is mounted on the end part 216 of the probe section 212 and accommodates a thermal insulator 60 and a thermal sensor 61 therein, namely, the thermal insulator 60 disposed inside the metal tip section 3, the thermal sensor 61 located inside at a top of the metal tip section 3 against the thermal insulator 61. Wires 62 has two ends and is positioned through the thermal insulator 60 wherein one end thereof connecting the thermal sensor 61 for accurately detecting temperature, and the other end connecting the temperature sensor device 4 (shown as FIG. 1), by aforementioned devices, the electronic thermometer 1 can efficiently detect temperature and reliably keep the detected temperature therein.

The temperature sensor device 4 assembled from the distal opening 201 in the first case 20 includes an electronic processor (not shown) and a display panel 40. The display panel 40 is correspondingly positioned to the viewing opening 203 for a readout of the detected temperature. The cap 5 is assembled on one of the distal opening 202 of the first case 20.

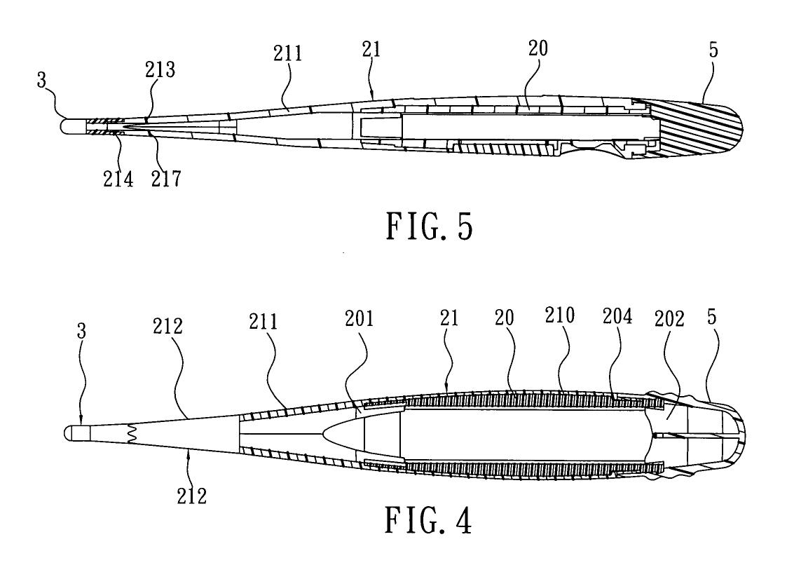

With reference to FIGS. 1 and 4, in assembly of the electronic thermometer 1, the second case 21 is integrally formed with the first case 20 by utilizing multi-material injection molding techniques to cover overall the first case 20 and catches recession 204 (please see FIG. 4), then the end of the wires 62 is passed through the probe section 212 and connected the temperature sensor device 4, and the metal tip section 3 is mounted on the end part 216 of the probe section 212, moreover, the temperature sensor device 4 is assembled on the first case 20 at a position that the display panel 40 is corresponding to the viewing opening 203, then insert the mating stem 214 into the probe section 212 and the probe section 212 engages with the connecting section 211 by the first roughness 213 and the second roughness 217, finally, mount the cap 5 on the distal opening 202 of the first case 20 to complete the assembly of the electronic thermometer 1 of the present invention.

The electronic thermometer 1 of the present invention in use, by way of placing the metal tip section 3 touch an available place of human body such as human's armpit, anus or under tongue for detecting temperature, then the detected temperature will be transmitted to the display panel 401 through the thermal sensor 61 and the wires 62 for an accurate readout of the detected temperature. Remarkably, the connecting section 211 of the electronic thermometer 1 is made of flexible material that can provide a convenient and comfortable touch with a human body; in addition, the mating stem 214 of the connecting section 211 can be inserted into the probe section 212 and the probe section 212 can firmly engage with the connecting section 211 by the first roughness 213 and the second roughness 217.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An electronic thermometer comprising:
a first case made of rigid material, being hollow body, having two distal openings opposite to each other, a viewing opening located at a midsection thereof and at least a recession disposed on an outer periphery thereof;
a second case comprising a cover section and a connecting section, both made of flexible material, and a probe section made of rigid material, wherein:
the cover section covering overall the firsts case and catching the recession, a mating stem being integrally formed in shrinkage at a distal end of the cover section; the connecting section forming a first roughness at a distal end thereof; the probe section having two end parts wherein one end part being engagable with the mating stem and forming a second roughness for corresponding to the first roughness of the connecting section, and an opposite end part being formed in small size;
a metal tip section mounted on the end part with small size of the probe section; and
a temperature sensor device including an electronic processor and a display panel assembled in the first case, wherein the display panel correspondingly positioned to the viewing opening; and
a cap assembled on the distal opening of the first case close to the recession.

2. The electronic thermometer as claimed in claim 1, wherein the first roughness of the connecting section and the second roughness of the probe section, for example, are at shape of serration.

3. The electronic thermometer as claimed in claim 1, wherein the metal tip section further accommodates a thermal insulator and a thermal sensor therein, the thermal insulator disposed on an inner of the metal tip section, the thermal sensor located inside at a top of the metal tip section against the thermal insulator, and wires have two ends positioned through the thermal insulator wherein one end thereof connecting the thermal sensor for accurately detecting temperature, and the other end connecting the temperature sensor device.

4. The electronic thermometer as claimed in claim 1, wherein the first case can be made of PC, PP, ABS.

5. The electronic thermometer as claimed in claim 1, wherein the second case can be made of TPR as flexible material.

6. An electronic thermometer comprising:
a first case being hollow body and having two distal openings opposite to each other and a viewing opening located at a midsection thereof;
a temperature sensor device including an electronic processor and a display panel assembled in the first case, wherein the display panel positioned corresponding to the viewing opening; and
a metal tip section mounted on an end of the first case and accommodating a thermal insulator and a thermal sensor therein, the thermal insulator disposed on an inner of the metal tip section, the thermal sensor located inside at a top of the metal tip section against the thermal insulator, and wires having two ends and being positioned through the thermal insulator wherein one end thereof connecting the thermal sensor for accurately detecting temperature, and the other end connecting the temperature sensor device.

7. The electronic thermometer as claimed in claim 6, wherein the thermal insulator is made of sponge.
